(19) United States
(12) Patent Application Publication
(10) Pub. No.: US 2014/0310613 A1
(43) Pub. Date: Oct. 16, 2014

(54) COLLABORATIVE AUTHORING WITH CLIPPING FUNCTIONALITY

(71) Applicant: MICROSOFT CORPORATION, Redmond, WA (US)

(72) Inventors: Eran Megiddo, Redmond, WA (US); David Rasmussen, Seattle, WA (US); Peter Leonard, Kirkland, WA (US); Christopher Pratley, Seattle, WA (US)

(73) Assignee: Microsoft Corporation, Redmond, WA (US)

(21) Appl. No.: 13/863,323

(22) Filed: Apr. 15, 2013

(51) Int. Cl. H04L 29/06; G06F 3/0484

(52) U.S. Cl. CPC H04L 65/403; G06F 3/04842
USPC 715/753

(57) ABSTRACT

Content may be captured in form of clippings and clipping metadata utilized to provide various features and services. Data may be imported from other sources. For example, search engine(s) may be used to annotate clippings with additional data. Clippings may be dragged into a document, made available through various platforms such as social networks, professional networks, messaging, and comparable ones. A clipping service may be provided to individual or groups of users accessible through thick or thin clients.

### BACKGROUND

Content processing applications and services, especially textual content, provide a number of controls for selecting, modifying aspects of content such as formatting, grammatical or stylistic corrections, even word replacements through synonym/antonym suggestions. In typical systems, such controls are available individually, sometimes independently or interdependently. Thus, users may be enabled to select and modify aspects of content they create or process, but they have to do it manually.

Content creation or modification in collaborative environments, where content may be created and processed by multiple users simultaneously and/or sequentially, may be specially challenging for authors trying to keep track of their own changes as well as others. Another aspect of content creation is use or re-use of existing content. In creating various combinations of content types for a variety of purposes, users may wish to take advantage of content from a variety of sources. However, copying and pasting existing content regardless of type may not be an efficient mechanism since integrating into the created content involves a number of manual steps. The use of existing content may become even more complex in collaborative environments.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to capturing content in form of clippings and utilizing clipping metadata to provide various features and services. Data may be imported from other sources. For example, search engine(s) may be used to annotate clippings with additional data. Clippings may be dragged into a document, made available through various platforms such as social networks, professional networks, messaging, and comparable ones. A clipping service may be provided to individual or groups of users accessible through thick or thin clients.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 includes a conceptual diagram illustrating a local and networked configuration environment, where collaborative authoring with clipping functionality may be implemented;

FIGS. 2A and 2B illustrate an overview of a collaborative authoring system with clipping functionality according to some embodiments;

FIG. 3 illustrates a screenshot of an example collaborative authoring user interface according to embodiments;

FIG. 4 illustrates a screenshot of the example collaborative authoring user interface of FIG. 3 with the clipping pane presented;

FIG. 5 illustrates a screenshot of the example collaborative authoring user interface of FIG. 4 with the clipping pane in shared clipping mode;

FIGS. 6A and 6B illustrate screenshots of example user interfaces showing drag and drop integration of a clipping into created content according to some embodiments;

FIG. 7 is a networked environment, where a system according to embodiments may be implemented;

FIG. 8 is a block diagram of an example computing operating environment, where embodiments may be implemented; and

FIG. 9 illustrates a logic flow diagram for a process of facilitating collaborative authoring with clipping functionality according to embodiments.

### DETAILED DESCRIPTION

As briefly described above, clipping functionality may be provided with a clipping pane acting as a staging area within a document, enable incorporation of content from different sources including web services, and annotation of clipping with metadata from search engines or other sources. Drag and drop authoring may be enabled along with notes history. Collaboration and sharing of notes, clippings may also be enabled.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for content collaboration with clipping functionality. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

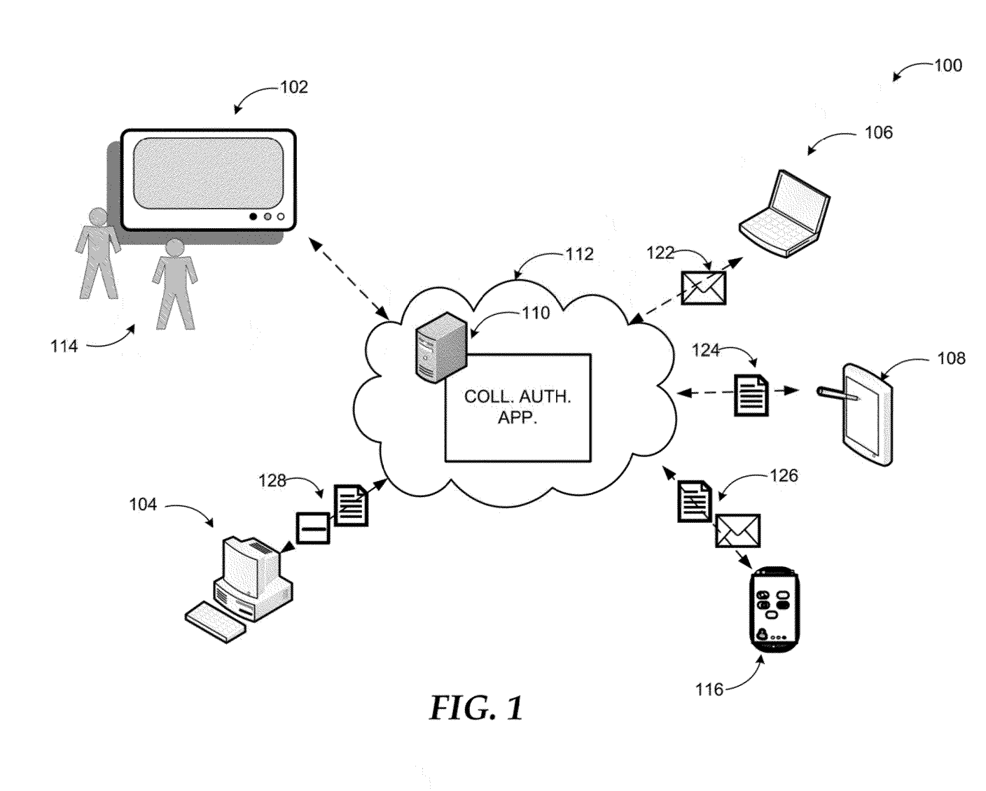

Referring to FIG. 1, conceptual diagram 100 illustrates a local and networked configuration environment, where collaborative authoring with clipping functionality may be implemented. The computing devices and computing environments shown in diagram 100 are for illustration purposes. Embodiments may be implemented in various local, networked, and similar computing environments employing a variety of computing devices and systems.

Diagram 100 represents a networked computing environment, where a collaborative authoring application (or service) 110 executed on a server may be accessed by a plurality of authors such as authors 114 to create and process content individually or collaboratively. The collaborative authoring application 110 may be accessed via network 112 by browsers or locally installed client applications on a desktop computer 104, a laptop computer 106, a tablet 108, a smart phone 116, a smart whiteboard 102, and similar devices. The collaborative authoring application may also be part of a hosted service executed on one or more servers.

The collaborative authoring application 110 may enable authors to create and modify content including, but not limited to, text, images, graphics, embedded objects (e.g., audio, video objects, etc.). Authors may create distinct portions of the content to be combined into a single, coherent work, may modify each other's (or their own) work, comment on each other's work, provide notes, and reply to comments/changes. Notifications of changes, comments, notes, and replies on the collaborative content (124, 126, 128) may be provided through various communication means, such as email 122, text messages, publication to social/professional networks, blogs, and similar means. The collaborative authoring application 110 may be a word processing application, a presentation application, a spreadsheet application, a note taking application, and comparable ones.

A collaborative authoring application according to embodiments may enable clipping functionality with a clipping pane acting as a staging area within a document. The application may also enable incorporation of content from different sources including web services, and annotation of clipping with metadata from search engines or other sources. Clippings may be inserted into the content through drag and drop also shared among multiple authors.

The example systems in FIG. 1 have been described with specific servers, client devices, applications, and interactions. Embodiments are not limited to systems according to these example configurations. A platform providing a collaborative authoring environment with clipping functionality may be implemented in configurations employing fewer or additional components and performing other tasks. Furthermore, specific protocols and/or interfaces may be implemented in a similar manner using the principles described herein.

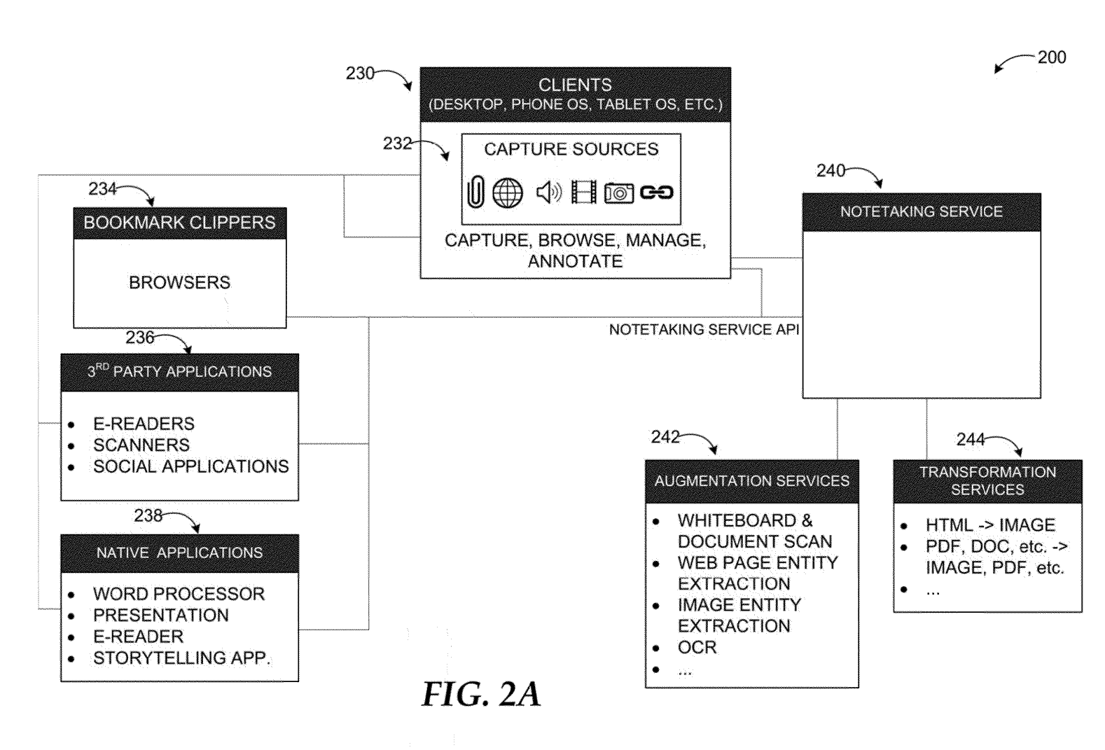

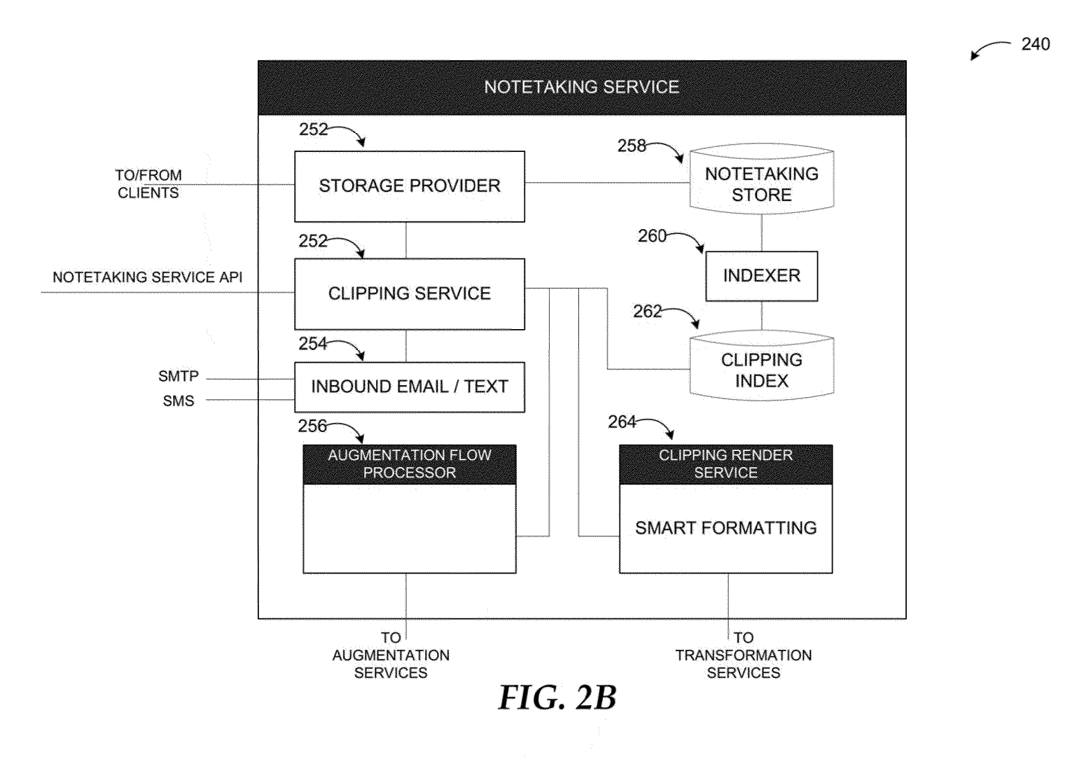

FIGS. 2A and 2B illustrate an overview of a collaborative authoring system with clipping functionality according to some embodiments.

In a system according to embodiments, content of any type (text, graphics, images, audio/video objects, etc.) may be captured on a variety of platforms such as displayed documents, web pages, any application user interface. Clipping item types may be extensible such as third party plug-ins. Clippings may be browsed, referenced, and/or explored on a special user interface or standard exploration user interface. Clippings may be annotated or integrated with notes through any input including ink. Clippings may be reused in various platforms. For example, clippings collected on a web page may be used later in a word processing document or presentation document, or shared through publishing on a network or messaging. Metadata and logic behind the clippings may enable augmentation. For example, a clipped movie title may be augmented with information associated with the movie such as gross, opening date, actors, etc. obtained through a search engine.

Example usage scenarios may include school/work project research, planning a wedding, planning a home renovation, planning trips, buying a car, collecting recipes, lists of items (e.g., books to read, movies to watch, gifts to buy, cool products), collecting information for hobbies, and comparable ones.

As shown in diagram 200, a system for providing clipping functionality in authoring content may include various clients 230 such as desktop, phone operating system, tablet operating system, and so on. The clients 230 may include capture sources 232 for capturing clipping content such as through attachment of files, web search, audio recording, video recording, hyperlinks, and/or image capture. Through the capture sources and clients, clippings may be captured, browsed, managed, and annotated. The system may also include bookmark clippers 234 such as various browsers.

The system may further include third party applications 236 such as e-readers, scanners, and social applications, as well as native applications 238 such as word processors, presentation applications, e-reader applications, storytelling applications, and similar ones. The native applications 238, third party applications 236, and bookmark clippers 234 may interact with a notetaking service 240 through a notetaking service application programming interface (API) according to some embodiments. The clients 230 may interact with the notetaking service through the same API or another interface.

The system may further include augmentation services 242 that may perform whiteboard and document scan, web page entity extraction, image entity extraction, optical character recognition, and similar tasks. The system may also include transformation services 244 for HTML to image conversion, PDF, document, and similar format to image or PDF format conversion, and comparable tasks.

The notetaking service 240 may include a storage provider 252 that may interact with the clients 230 directly, a clipping service 252, an inbound email/text module for receiving incoming communication, a notetaking store 258, an indexer 260, and a clipping index store 262. The indexer 260 may index content stored in notetaking store 258 and clipping index store 262 such that stored clippings are searchable similar to stored content.

The notetaking service 240 may also include an augmentation flow processor 256 for managing augmentation services and a clipping render service 264 for smart formatting operations in conjunction with transformation services 244. The notetaking service 240 is an example implementation of some embodiments. A clipping service may also be integrated into other types of services/applications.

In some embodiments, a simple item based access may be used, where clippings are treated as items and pages may contain one or more clippings and other rich annotations. Metadata may be used on items with schema for common types (e.g. product, recipe, person, map, location, article, movie, event, and comparable ones). Type may be extensible. Furthermore, the service API may be used for create, read, update, delete (CRUD) operations. Query support may also be provided, and clipping renderings may be as HTML, as image, or PDF/doc as image, etc.

In other embodiments, bookmark clippers may be used in conjunction with a script (e.g., DIV and image based selection model). Code may be shared for selecting web content with notetaking, word processing, presentation, storytelling applications, for example. A user interface may be provided for optionally tagging and specifying where to put the clip, etc. Content may be pushed to the service and browser add-ins may be provided for different browsers.

In further embodiments, a call service API may be provided to create, get, or query clippings. A hostable web user interface may be used for browsing and picking clippings, which may be hostable as a taskpane applet or hostable in web experiences. For example, a clipping may be inserted into a story by pulling up clippings picker, browsing them, filtering, selecting and inserting. Operating system integration may include share function, picture and/or file picker function, etc. Moreover, third party applications may be enabled to publish clippings via share function. Clippings may also be pulled from a notetaking application using picture and file picker contracts.

In the augmentation service, search engine capabilities may be leveraged to augment clippings. Examples may include, but are not limited to extracting a primary entity from a web page; a product, recipe etc. from a web page; an article title, author and text from a blog site; an itinerary from an email; and a camera document and/or a whiteboard scan. Images may be deskewed, contrast adjusted, or stitched to obtain a clean image, items may be recognized from a camera image (e.g., bar codes, similar labels). An extensible pipeline may be used such that others can add specific item support (e.g. calendar recognition from email for consumer family calendar).

For the clippings browser experience, clippings may be provided with optimized views, a visual grid like browsing layout may be provided, a “Cover page” may be visual, explorable, and easily shared. Furthermore, clippings may be viewed by recency, tags, location, or similar aspects. Annotations on clippings may become part of clippings. From other experiences, the original clipping or the annotated version may be reused, where both may be exposed through the service. For the reading experience, clippings, notes and annotations may be stored in clipping service. Storytelling and modern authoring (in word processing, presentation, or similar environments) capabilities may be provided. Items from clipping store may be inserted into a story, a word processing document, a presentation, and so on. For service component sharing, consumer and storytelling may need an email in bound pipe. Storytelling may have a similar “augmentation” entity extraction and may be able to share the primary augmentation workflow engine.

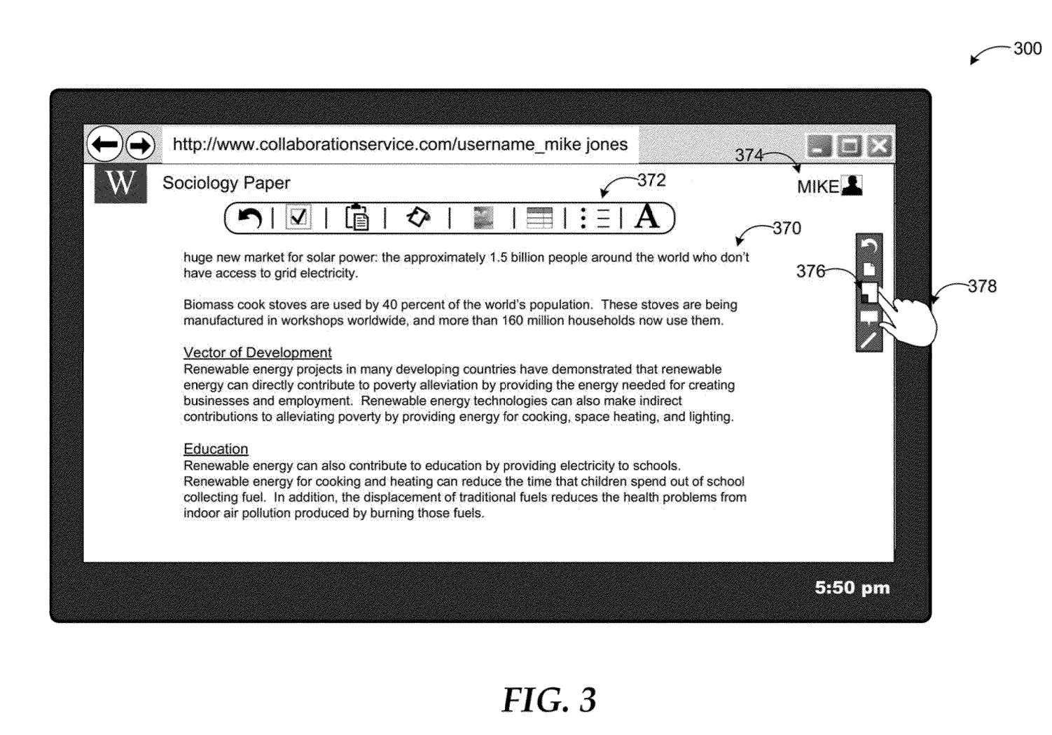

FIG. 3 illustrates a screenshot of an example collaborative authoring user interface according to embodiments.

In the example screenshot 300, a sociology paper is being collaboratively created by a team. The user interface presents the created content 370 with editing controls 372. While the edit view for the content being created in the example screenshot 300 shows a single user 374, a control element on the user interface may activate a view pane listing collaborators and enabling communication (e.g., viewing comments of the collaborators) with them. According to some embodiments, a control 376 may enable a clippings user interface to appear upon activation 378 (e.g., by touch).

A collaborative authoring application user interface may also present additional controls, which may be activated by touch or gesture input, for example, to switch between different modes or user interfaces, providing a comment, editing the content, publishing the content or an author's edits, etc. The information associated with the collaborators and modified content may be hidden/presented based on current user's choice (e.g., toggling of a control on the user interface).

The browser user interface shown in the screenshot 300 is for illustration purposes. In addition to standard elements such as an address of the current web page, a search box, command menus, and a tab indicating the web page, other elements may be provided in various locations and in any order using the principles described herein. A collaborative authoring application user interface may also include custom elements like in a locally installed and executed application.

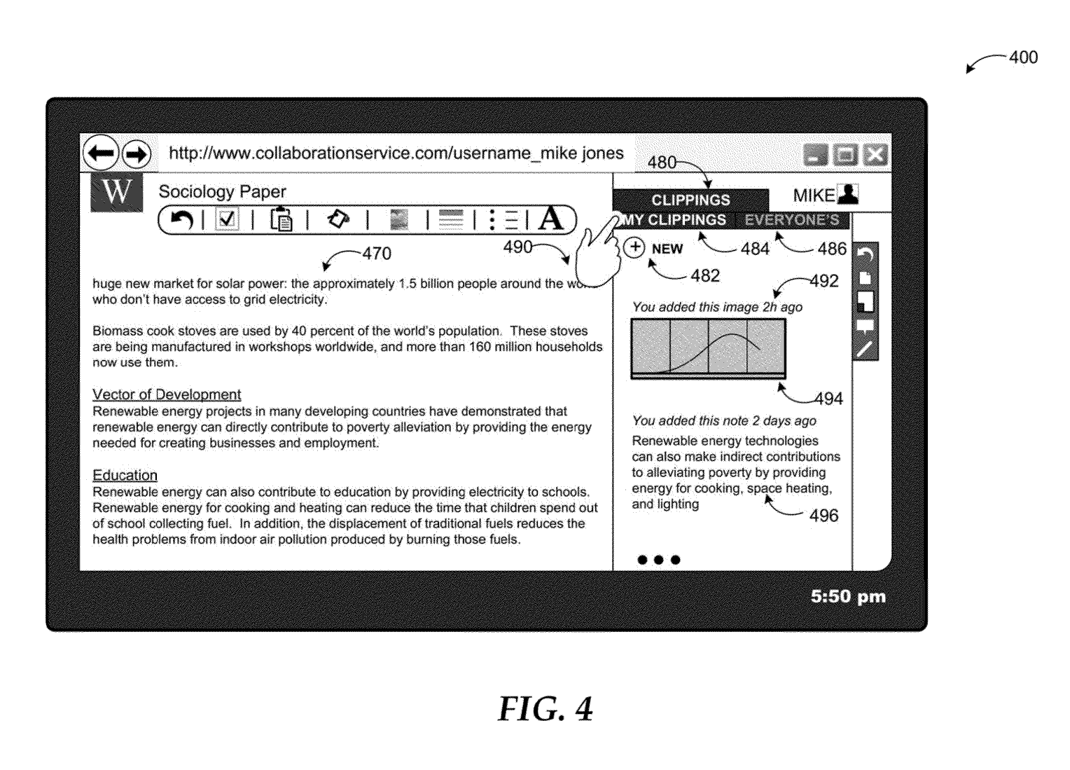

FIG. 4 illustrates a screenshot of the example collaborative authoring user interface of FIG. 3 with the clipping pane presented.

Screenshot 400 shows the main user interface of the collaborative authoring service with the created content 470 and edit controls along with the clippings user interface 480. Clipping user interface 480 may be a staging area within a document enabling incorporation of content from different sources including web services and annotation of clipping with metadata from search engines or other sources.

In a collaborative environment, clippings may be presented in two modes: the author's own clippings (my clippings 484) and shared clippings (everyone's clippings 486). In the example screenshot 400, the author's own clippings are selected (490). The clippings user interface presents different types of clippings such as image 494 and text 496. Summary information 492 associated with a clipping may indicate who provided the clipping and when. Other information may also be provided such as a source of the clipping (e.g., a website). A control 482 may enable the author to create new clippings. The clippings user interface may be scrollable or flippable allowing a range of clippings to be presented.

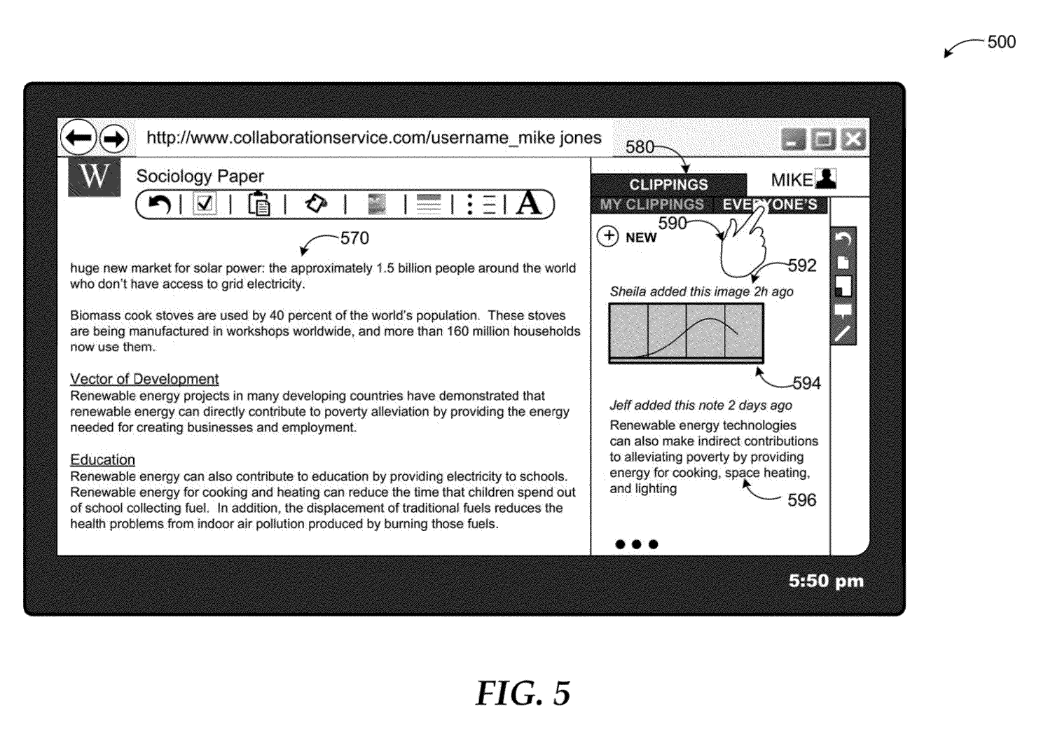

FIG. 5 illustrates a screenshot of the example collaborative authoring user interface of FIG. 4 with the clipping pane in shared clipping mode.

As shown in example screenshot 500, the content 570 may be collaboratively created by multiple authors. Upon selecting (590) the shared clippings view on the clippings user interface 580, the author may be presented with the clippings collected/stored by the collaborating authors such as image 594, text 596, etc. As the clipping information 592 shows, the authors for each clipping may be different. By allowing clippings from different authors to be shared, the collaborative authoring experience may be enhanced, where individual authors may take advantage of clippings found by other authors.

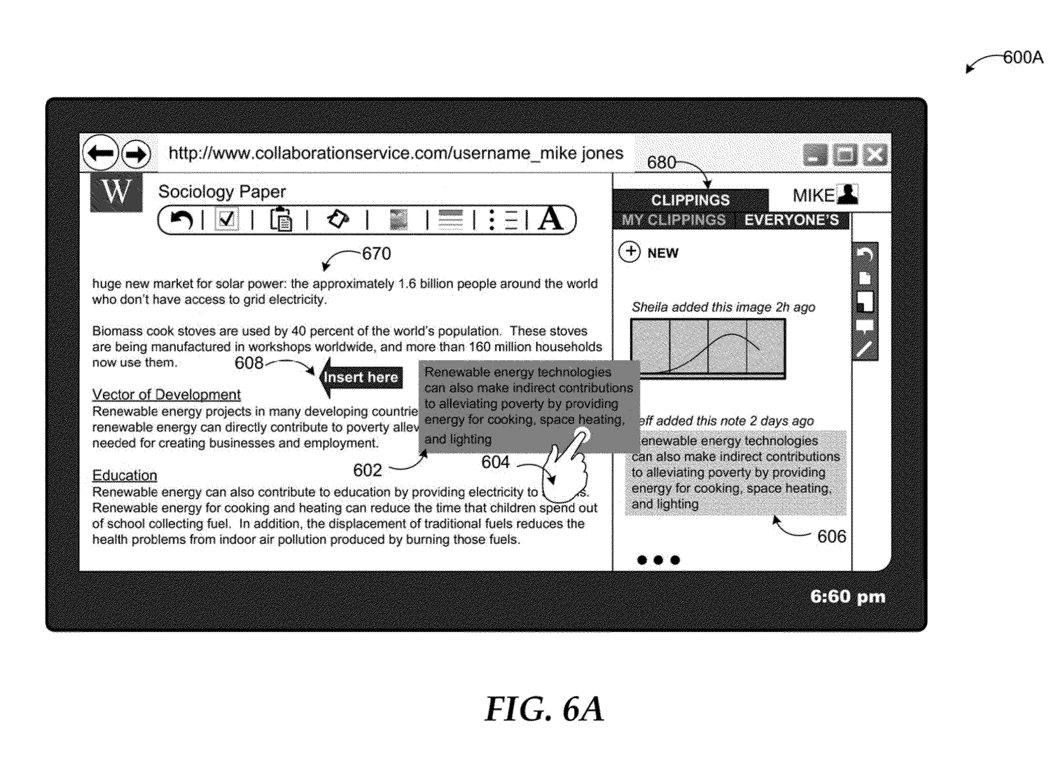

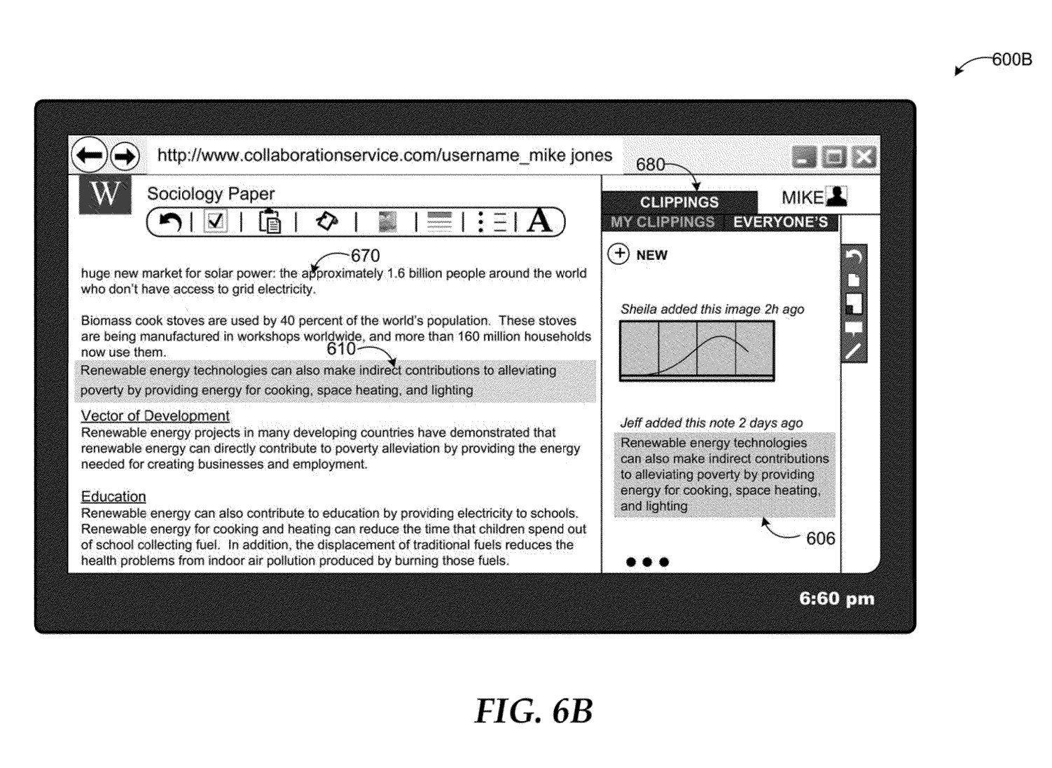

FIGS. 6A and 6B illustrate screenshots of example user interfaces showing drag and drop integration of a clipping into created content according to some embodiments.

In screenshot 600A, a user action 604 is shown dragging textual clipping 606 into the content 670. As the clipping is dragged, the original clipping 606 may still be displayed while a transition version 602 may be displayed using a highlighting or shading scheme to visualize the movement of the clipping into the user desired location in the content 670.

In some embodiments, a guide 608 may be displayed offering the user a suggestion as to where the clipping should be inserted. Upon insertion, the content around the inserted clipping may be adjusted, for example, existing text may be re-flowed, existing text may be placed adjacent to an inserted image or object, and so on. The inserted clipping may also be reformatted to match a style and format of the content 670. For example, font type, size, etc. of textual clippings may be matched to that of the content. Image clippings may be resized, sharpened, blurred, fitted with a frame, etc.

Example screenshot 600B shows the textual clipping 606 integrated into the content 670 as portion 610. In the example scenario, the textual content is inserted as a separate paragraph. Thus, in addition to formatting and style matches, the content itself may also be analyzed and proper sentence/paragraph selected for inserted clippings. Similarly, image, graphics, and other object type clippings may also be adjusted to fit into the content 670.

The examples in FIG. 1 through 6B have been described with specific user interface elements, configurations, and presentations. Embodiments are not limited to systems according to these example configurations. A collaborative authoring environment with clipping functionality may be implemented in configurations using other types of user interface elements, presentations, and configurations in a similar manner using the principles described herein.

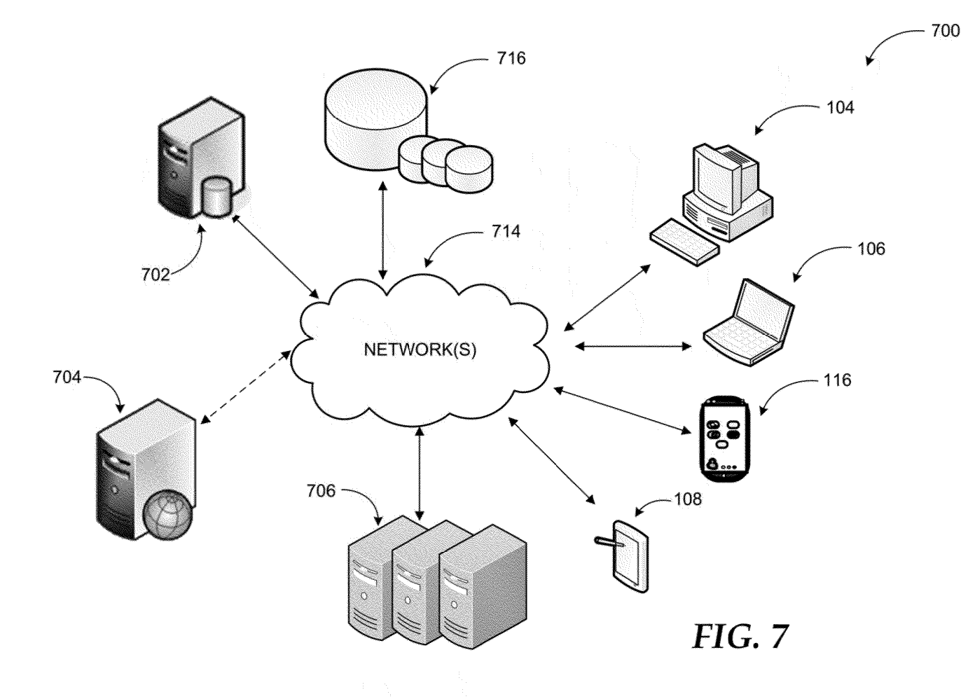

FIG. 7 is an example networked environment, where embodiments may be implemented. A platform providing a collaborative authoring environment may be implemented via software executed over one or more servers 706 such as a hosted service. The platform may communicate with client applications on individual computing devices such as the desktop computer 104, laptop computer 106, smart phone 116, and tablet 108 (‘client devices’) through network(s) 714.

Client applications executed on any of the client devices may facilitate communications with hosted content processing applications executed on servers 706, or on individual server 704. A collaborative authoring application executed on one of the servers may facilitate collaboration with clipping functionality as discussed above. The collaborative authoring application may retrieve relevant data from data store(s) 716 directly or through database server 702, and provide requested services to the user(s) through the client devices.

Network(s) 714 may comprise any topology of servers, clients, Internet service providers, and communication media. A system according to embodiments may have a static or dynamic topology. Network(s) 714 may include secure networks such as an enterprise network, an unsecure network such as a wireless open network, or the Internet. Network(s) 714 may also coordinate communication over other networks such as Public Switched Telephone Network (PSTN) or cellular networks. Furthermore, network(s) 714 may include short range wireless networks such as Bluetooth or similar ones. Network(s) 714 provide communication between the nodes described herein. By way of example, and not limitation, network(s) 714 may include wireless media such as acoustic, RF, infrared and other wireless media.

Many other configurations of computing devices, applications, data sources, and data distribution systems may be employed to implement a platform providing a collaborative authoring environment with clipping functionality. Furthermore, the networked environments discussed in FIG. 7 are for illustration purposes only. Embodiments are not limited to the example applications, modules, or processes.

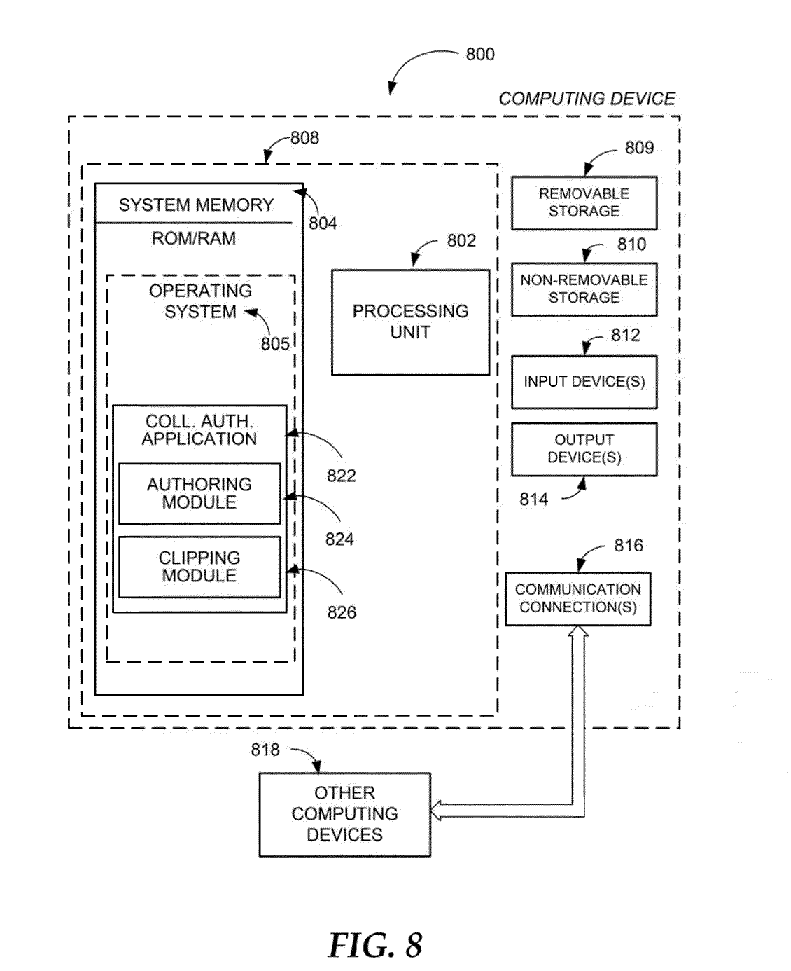

FIG. 8 and the associated discussion are intended to provide a brief, general description of a suitable computing environment in which embodiments may be implemented. With reference to FIG. 8, a block diagram of an example computing operating environment for an application according to embodiments is illustrated, such as the computing device 106. In a basic configuration, computing device may be any computing device with communication capabilities, and include at least one processing unit 812 and a system memory 804. The computing device 800 may also include a plurality of processing units that cooperate in executing programs. Depending on the exact configuration and type of computing device, a system memory 804 may be volatile (such as RAM), non-volatile (such as ROM, flash memory, etc.) or some combination of the two. The system memory 804 typically includes an operating system 805 suitable for controlling the operation of the platform, such as the WINDOWS®, WINDOWS MOBILE®, or WINDOWS PHONE® operating systems from MICROSOFT CORPORATION of Redmond, Wash. The system memory 804 may also include one or more software applications such as collaborative authoring application 822, an authoring module 824, and a clipping module 826.

The collaborative authoring application 822 may enable creation and editing of content by multiple authors. The collaborative authoring application 822 through the authoring module 824 and clipping module 826 may enabled authors to create/edit content, communicate about the content creation/edit process, notify authors about changes that affect a particular author, notify about co-authors of changes, restore or compare versions and/or notes, while using private or shared clippings. The collaborative authoring application 822, the authoring module 824, and the clipping module 826 may be separate applications or integrated modules of a hosted service. This basic configuration is illustrated in FIG. 8 by those components within a dashed line 802.

The computing device 800 may have additional features or functionality. For example, the computing device 800 may also include additional data storage devices (removable and/or non-removable) such as, for example, magnetic disks, optical disks, or tape. Such additional storage is illustrated in FIG. 8 by a removable storage 814 and a non-removable storage 816. Computer readable storage media may include volatile and nonvolatile, removable and non-removable media implemented in any method or technology for storage of information, such as computer readable instructions, data structures, program modules, or other data. The system memory 804, removable storage 814 and the non-removable storage 816 are all examples of computer readable memory device. Computer readable memory devices include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other physical medium which can be used to store the desired information and which can be accessed by the computing device 800. Any such computer readable storage media may be part of the computing device 800. The computing device 800 may also have the input device(s) 818 such as keyboard, mouse, pen, voice input device, touch input device, an optical capture device for detecting gestures, and comparable input devices. An output device(s) 820 such as a display, speakers, printer, and other types of output devices may also be included. These devices are well known in the art and need not be discussed at length here.

Some embodiments may be implemented in a computing device that includes a communication module, a memory device, and a processor, where the processor executes a method as described above or comparable ones in conjunction with instructions stored in the memory device. Other embodiments may be implemented as a computer readable memory device with instructions stored thereon for executing a method as described above or similar ones. Examples of memory devices as various implementations of hardware are discussed above.

The computing device 800 may also contain communication connections 822 that allow the device to communicate with other devices 826, such as over a wired or wireless network in a distributed computing environment, a satellite link, a cellular link, a short range network, and comparable mechanisms. Other devices 826 may include computer device(s) that execute communication applications, web servers and the comparable device 108. Communication connection(s) 822 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

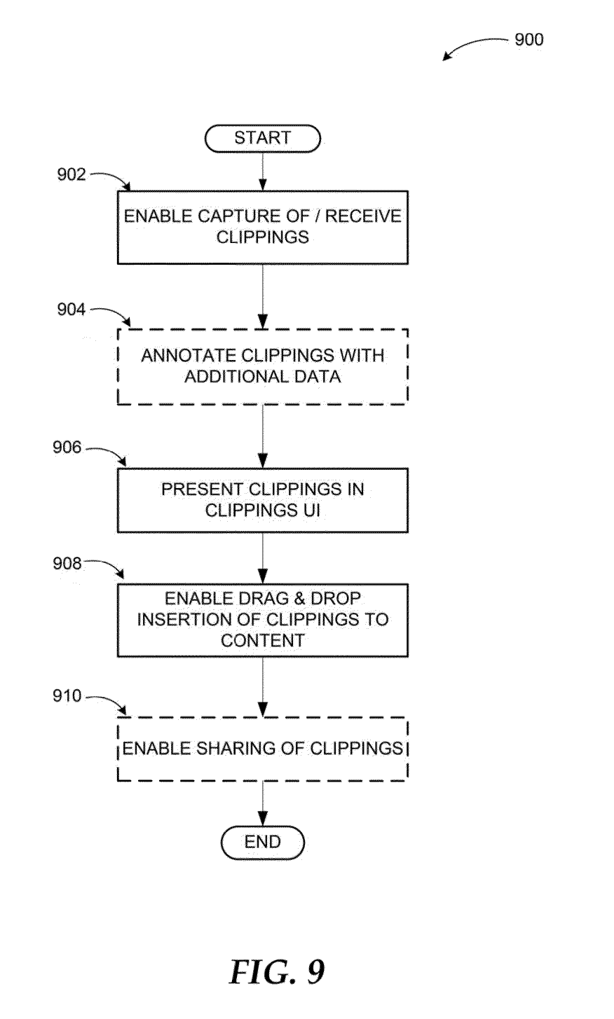

FIG. 9 illustrates a logic flow diagram for a process 900 of facilitating collaborative authoring with clipping functionality according to embodiments. The process 900 may be implemented on a server or other computing device.

The process 900 begins with an operation 902, where an authoring application/service may capture (e.g., through an integrated clipping service) or receive clippings from one or more authors. At optional operation 904, the authors may be enabled to annotate the clippings, where the annotations may be preserved in clipping metadata. At operation 906, the collection of clippings may be presented in a clippings user interface enabling authors to review, share, sort, search, and perform comparable actions on the clippings.

At operation 908, the authors may be enabled to drag and drop the clippings into content with automated matching of format, size, location, style, and other aspects of the clippings and/or surrounding content to provide a seamless integration of the inserted clipping and the content. At optional operation 910, clippings may be shared through a shared clippings view of the clippings user interface or similar means.

The operations included in the process 900 are for illustration purposes. Providing a collaborative authoring environment with clipping functionality may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for enabling collaborative authoring, the method comprising:
one of enabling a capture of and receiving a clipping;
presenting a plurality of clippings in a clippings user interface (UI) in conjunction with content being edited; and
enabling insertion of a selected clipping from the clippings UI into the content by automatically integrating the selected clipping into the content.

2. The method of claim 1, further comprising enabling annotation of the clipping with metadata from one or more of a search engine and user notes.

3. The method of claim 2, further comprising enabling collaboration and sharing of one or more of the clippings and annotations of the clippings among collaborating authors through one or more of publishing on a network and messaging.

4. The method of claim 2, further comprising exposing an original clipping and an annotated version of the clipping for selection by a user.

5. The method of claim 1, further comprising enabling insertion of the selected clipping through a drag and drop action.

6. The method of claim 1, wherein enabling the capture of the clipping includes one or more of an attachment of a file, a web search, an audio recording, a video recording, a hyperlink selection, and an image capture.

7. The method of claim 1, further comprising enabling one or more of browsing, referencing, sorting, and exploration of the clippings in the clippings UI.

8. The method of claim 1, further comprising rendering the clippings in one of a hypertext markup language (HTML) format, a document format, and an image format.

9. The method of claim 1, further comprising presenting the clippings in order of one of a recency, a type, a tag associated with each clipping, and a location of the clippings on the clippings UI.

10. The method of claim 1, further comprising enabling a third party application to publish clippings via a share function.

11. The method of claim 1, further comprising presenting a notes history associated with the clippings.

12. A computing device for providing a collaborative authoring environment, the computing device comprising:
a memory;
a processor coupled to the memory, the processor executing a collaborative authoring application, wherein the collaborative authoring application is configured to:
enable a capture of a clipping through a capture source employing one or more of an attachment of a file, a web search, an audio recording, a video recording, a hyperlink selection, and an image capture;
present a plurality of clippings in a clippings user interface (UI) in conjunction with content being edited;
enable annotation of the clipping with metadata from one or more of a search engine and user notes; and
enable insertion of a selected clipping from the clippings UI into the content by automatically integrating the selected clipping into the content.

13. The computing device of claim 12, wherein the collaborative authoring application is configured to interact with an augmentation service to perform one or more of a whiteboard scan, a document scan, a web page entity extraction, an image entity extraction, and an optical character recognition.

14. The computing device of claim 12, wherein the collaborative authoring application is further configured to enable interact with a transformation service to convert a format of the clipping.

15. The computing device of claim 12, wherein one or more native and third party applications are enabled to interact with the collaborative authoring application through a service application programming interface (API) and perform one or more create, read, update, delete (CRUD) operations.

16. The computing device of claim 12, wherein the collaborative authoring application is further configured to employ an indexer to index the clippings such that the clippings are searchable.

17. The computing device of claim 12, wherein the collaborative authoring application is further configured to provide a hostable web user interface for browsing and selecting the clippings.

18. The computing device of claim 12, wherein the collaborative authoring application is one of a notetaking application, a word processing application, a presentation application, an e-reader application, and a storytelling application, and the clipping includes one or more of textual content, an image, a graphic, an embedded audio object, and an embedded video object.

19. A computer-readable memory device with instructions stored thereon for enabling collaborative authoring, the instructions comprising:
enabling a capture of a clipping through a capture source employing one or more of an attachment of a file, a web search, an audio recording, a video recording, a hyperlink selection, and an image capture;
presenting a plurality of clippings in a clippings user interface (UI) in conjunction with content being edited;
enabling collaboration and sharing of one or more of the clippings and annotations of the clippings among collaborating authors through one or more of publishing on a network and messaging; and
enabling insertion of a selected clipping from the clippings UI into the content by automatically integrating the selected clipping into the content, wherein the integration includes adjustment of one or more of the selected clipping and content around the inserted clipping.

20. The computer-readable memory device of claim 19, wherein adjustment includes modification of one or more of a size, a format, a style, a location, and a placement of the inserted clipping and the content around the inserted clipping.
